(19) United States
(12) Patent Application Publication
(10) Pub. No.: US 2026/0134530 A1
(43) Pub. Date: May 14, 2026

(54) SYSTEM, DEVICE, AND METHOD FOR DETECTING DEFECTS IN PHOTOVOLTAIC WAFER BY USING DEEP LEARNING

(71) Applicant: HANWHA SOLUTIONS CORPORATION, Seoul (KR)

(72) Inventors: Byeong Gyun KIM, Seoul (KR); Minki KIM, Seoul (KR)

(21) Appl. No.: 19/121,149

(22) PCT Filed: Jul. 27, 2023
(86) PCT No.: PCT/KR2023/010898

§ 371 Date: Apr. 15, 2025

(30) Foreign Application Priority Data
Nov. 16, 2022 (KR) 10-2022-0153412

(51) Int. Cl. G06T 7/00; G06T 1/00; G06T 5/70; G06T 5/80; G06T 7/90

(52) U.S. Cl. CPC G06T 7/0008; G06T 1/0007; G06T 5/70; G06T 5/80; G06T 7/90; G06T 2207/20081; G06T 2207/20084; G06T 2207/30148

(57) ABSTRACT

The present disclosure provides a system for detecting a defect in a photovoltaic wafer, the system including imaging equipment configured to obtain a target image of a photovoltaic wafer, and a defect detection device configured to determine presence or absence of at least one defect in the photovoltaic wafer in the target image, wherein the defect detection device is further configured to detect the presence or absence of the at least one defect, which includes a defective state with at least one fault in the photovoltaic wafer based on a fault detection deep learning model, and at least one black spot present on the photovoltaic wafer based on a black spot detection algorithm, and a normal state of the photovoltaic wafer.

### TECHNICAL FIELD

The present disclosure relates to a system, device, and method for detecting a defect in a photovoltaic wafer by using deep learning.

### BACKGROUND ART

Recently, as climate change and environmental pollution caused by fossil fuels have become more serious, interest in the use of eco-friendly alternative energy has increased, and solar power generation is attracting attention as the most promising alternative energy source to replace fossil fuels.

Solar power generation converts solar energy directly into electrical energy and supplies it to a load. Such a solar power generation system collects energy by using a photovoltaic wafer. Here, a defect occurring in the photovoltaic wafer may result in a drastic decrease in the amount of solar power generation, or a high risk of fire. Therefore, a technique to detect a defect in a photovoltaic wafer manufacturing stage is significantly important.

FIG. 1 is a configuration diagram of a related-art photovoltaic wafer inspection system.

Referring to FIG. 1, in a related-art photovoltaic wafer manufacturing process, an electroluminescence (EL) camera 10 may be used to diagnose whether there is a defect in a photovoltaic wafer 1, and classify normal products and defective products. A measurement method using the EL camera 10 utilizes the effect of emitting light of a unique wavelength band of the photovoltaic wafer 1 when the EL camera 10 and the completed photovoltaic wafer 1 are placed in a darkroom 20, and a current is applied through a power supplier 30. In the case of a general silicon solar cell, when a current is applied, a wavelength of about 1.1 μm is emitted, and at this time, the related-art photovoltaic wafer inspection system uses the EL camera 10 to detect light in the corresponding wavelength band, and uses a monitor 40 to check an image and detect a defect in the photovoltaic wafer 1.

However, a related-art defect detection system using the EL camera 10 is able to detect only cracks among various defects. Therefore, when there are other defects than cracks in the photovoltaic wafer 1, a large number of under-detections occur that are failures to detect the defects. In addition, the detection performance of the related-art EL camera 10 is poor, and thus, a large number of over-detections occur that are incorrect determination of cracks despite the absence of defects in the photovoltaic wafer 1.

As such, photovoltaic wafers with under-detections are assembled into photovoltaic modules and then determined to be faulty, leading to a decrease in productivity. In addition, photovoltaic wafers 1 with over-detections are determined to be faulty and thus discarded even though they are normal, which has been a cause of increased manufacturing costs.

To solve these issues, it is necessary to develop a system for detecting a defect in a photovoltaic wafer, which is capable of detecting various defects in a photovoltaic wafer with improved detection performance by using a deep learning model that has learned EL images.

### DISCLOSURE

### Technical Problem

In order to solve the above-described problems of the related art, the present disclosure is to provide a detection system, device, and method capable of detecting various defects in a photovoltaic wafer by using deep learning.

In addition, the present disclosure is to provide a detection system, device, and method capable of accurately detecting black spots and classifying them by type.

The technical objectives of the present disclosure are not limited to those mentioned above, and other technical objectives not mentioned herein may be clearly understood by those of skill in the art to which the present disclosure pertains from the following description.

### Technical Solution

In order to achieve the above-described objectives, a system for detecting a defect in a photovoltaic wafer, according to the present disclosure, includes imaging equipment configured to obtain a target image of a photovoltaic wafer, and a defect detection device configured to determine presence or absence of at least one defect in the photovoltaic wafer in the target image, wherein the defect detection device is further configured to detect the presence or absence of the at least one defect, which includes a defective state with at least one fault in the photovoltaic wafer based on a fault detection deep learning model, and at least one black spot present on the photovoltaic wafer based on a black spot detection algorithm, and a normal state of the photovoltaic wafer.

In addition, the fault detection deep learning model is trained by training data associated with at least one defect identified in at least one training image of the photovoltaic wafer.

In addition, the black spot detection algorithm is configured to, based on an area of a region of the black spot detected in the target image being greater than or equal to a threshold value, determine the photovoltaic wafer to be in the defective state.

In addition, the black spot detection algorithm is further configured to, based on the area of the region of the black spot being less than the threshold value, determine the photovoltaic wafer to be in the normal state.

In addition, the imaging equipment further includes an interface unit configured to transmit and receive, to and from the defect detection device, a location of a storage device in which the target image is stored, and a result of detecting a defect in the photovoltaic wafer.

In addition, the defect detection device is further configured to scan the storage device in real time, and download, based on the target image being stored in the storage device, the target image from the storage device.

In addition, the defect detection device further includes an alarm unit configured to, based on the photovoltaic wafer being in the defective state, provide an alarm.

In addition, a device for detecting a defect in a photovoltaic wafer, according to the present disclosure, includes a storage unit storing a fault detection deep learning model and a black spot classification deep learning model both configured to detect presence or absence of a defect of a photovoltaic wafer in a target image of the photovoltaic wafer, wherein the target image is obtained by imaging equipment, and a processor configured to detect any one of a defective state or a normal state of the photovoltaic wafer, based on the target image, the fault detection deep learning model, and the black spot classification deep learning model.

In addition, a method of detecting a defect in a photovoltaic wafer, according to the present disclosure, includes receiving, by a defect detection device, a target image of the photovoltaic wafer obtained from imaging equipment, and detecting, by the defect detection device, presence or absence of at least one defect in the photovoltaic wafer, based on the target image, wherein, in the detecting of the presence or absence of the at least one defect, the presence or absence of the at least one defect includes a defective state with at least one fault in the photovoltaic wafer based on a fault detection deep learning model, and at least one black spot present on the photovoltaic wafer based on a black spot detection algorithm, and a normal state of the photovoltaic wafer.

In addition, the method further includes generating, by the defect detection device, the fault detection deep learning model through learning of training data associated with at least one defect identified in at least one training image of the photovoltaic wafer.

In addition, the detecting of the presence or absence of the at least one defect includes preprocessing the target image by using the black spot detection algorithm, calculating an area of a region of the black spot detected in the preprocessed target image, and determining, based on the area of the region of the black spot being greater than or equal to a threshold value, the photovoltaic wafer to be in the defective state.

In addition, the detecting of the presence or absence of the at least one defect includes, based on the area of the black spot region being less than the threshold value, determining the photovoltaic wafer to be in the normal state.

In addition, the preprocessing of the target image includes correcting an angle in the target image, and removing busbars and noise from the target image.

In addition, the method further includes, prior to the calculating of the area of the region of the black spot, determining, by the defect detection device, a brightness of the target image, and determining the region of the black spot according to the brightness of the target image.

In addition, the method further includes, based on the photovoltaic wafer being in the defective state, providing, by the defect detection device, an alarm.

### Advantageous Effects

Unlike related-art defect detection systems that may detect only cracks from an image of a photovoltaic wafer, a system, device, and method for detecting a defect in a photovoltaic wafer by using deep learning, according to the present disclosure, have an advantage of being able to detect and classify cracks, scratches, LCO, hotspots, injector, LDSE, and black spots.

In addition, the system, device, and method for detecting a defect in a photovoltaic wafer by using deep learning, according to the present disclosure, may accurately detect black spots by using a black spot detection algorithm, thereby suppressing factors that increase manufacturing costs in a photovoltaic wafer manufacturing process, and increasing the reliability of a photovoltaic wafer.

Finally, the system, device, and method for detecting a defect in a photovoltaic wafer by using deep learning, according to the present disclosure, have an advantage of being able to quickly identify an operation that causes defects during a photovoltaic wafer production process, by classifying black spots by type.

### DESCRIPTION OF DRAWINGS

FIG. 1 is a schematic diagram of a related-art electroluminescence (EL)-type photovoltaic wafer defect detection system.

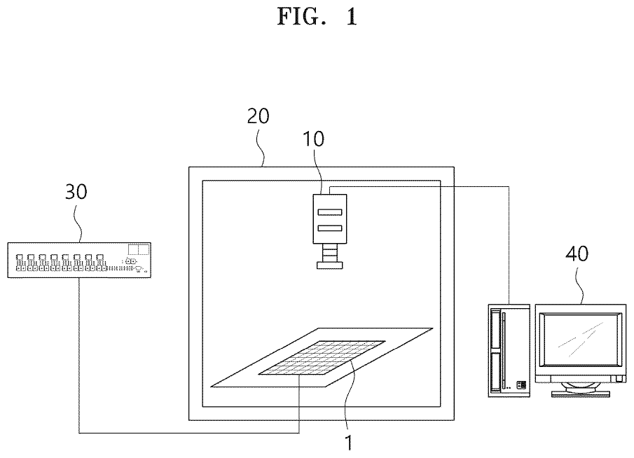

FIG. 2 is a detailed block diagram of a first photovoltaic wafer defect detection system according to an embodiment of the present disclosure.

FIG. 3 is a detailed block diagram of a second photovoltaic wafer defect detection system according to an embodiment of the present disclosure.

FIG. 4 shows specific images of fault types that may occur in a photovoltaic wafer.

FIG. 5 is a detailed flowchart of a method of detecting a defect in a photovoltaic wafer, according to an embodiment of the present disclosure.

FIG. 6 is a detailed flowchart of an image preprocessing method of a black spot detection algorithm.

FIG. 7 is an image for describing in detail an image cropping operation of a preprocessing algorithm.

FIG. 8 is an image for describing in detail an image warping operation of a preprocessing algorithm.

FIG. 9 is an image for describing in detail a busbar removal operation of a preprocessing algorithm.

FIG. 10 is an image for describing in detail a noise removal operation of a preprocessing algorithm.

### BEST MODE

The above objectives and solutions of the present disclosure and the effects thereof will become clearer through the following detailed description with reference to the accompanying drawings, and accordingly, those of skill in the art to which the present disclosure pertains may easily implement the technical idea of the present disclosure. In addition, in describing the present disclosure, if it is determined that a detailed description of a known technique related to the present disclosure may unnecessarily obscure the gist of the present disclosure, the detailed description will be omitted.

In the present specification, terms such as “or” or “at least one” may indicate any one of the words listed together, or a combination of thereof. For example, “or B” and “at least one of and B” may include only one of A or B, and may also include both A and B.

In the present specification, terms such as ‘first’ or ‘second’ may be used to describe various elements, but the elements should not be limited by these terms. In addition, these terms should not be construed as limiting the order of components, and may be used for the purpose of distinguishing one component from another. For example, a ‘first component’ may be referred to as a ‘second component’, and similarly, a ‘second component’ may be referred to as a ‘first component’.

Hereinafter, preferred embodiments according to the present disclosure will be described in detail with reference to the accompanying drawings.

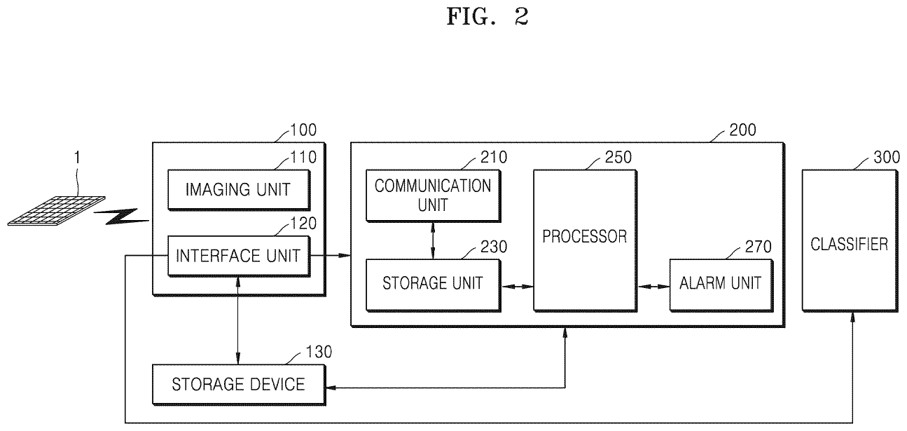

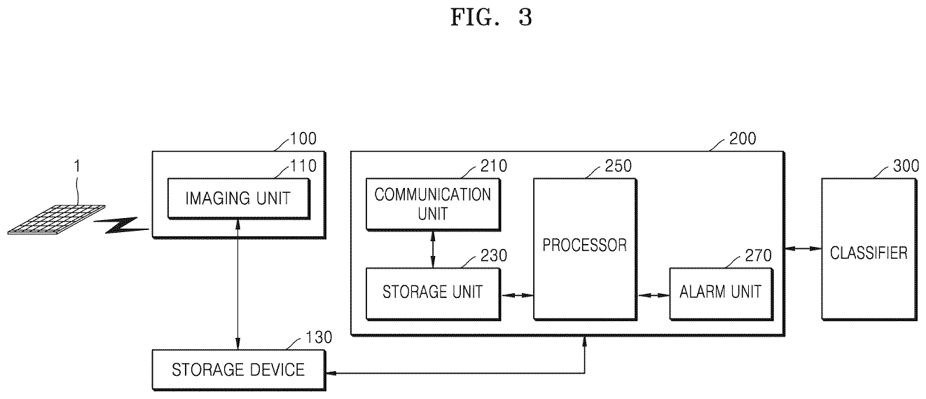

FIG. 2 is a detailed block diagram of a first photovoltaic wafer defect detection system according to an embodiment of the present disclosure, and FIG. 3 is a detailed block diagram of a second photovoltaic wafer defect detection system according to an embodiment of the present disclosure.

Referring to FIGS. 2 and 3, a photovoltaic wafer defect detection system according to an embodiment of the present disclosure may include imaging equipment 100, a storage device 130, a defect detection device 200, and a classifier 300.

The imaging equipment 100 may receive, through an imaging unit 110, light emitted from a photovoltaic wafer 1, and generate a target image. For example, the imaging unit 110 may include an electroluminescence (EL) camera and a thermal imaging camera.

In detail, the target image is an image obtained by photographing the photovoltaic wafer 1 through the imaging unit 110, and may be used by the defect detection device 200 to determine whether the photovoltaic wafer 1 has a defect or a black spot.

According to an embodiment of the present disclosure, in a case in which an EL camera is used as the imaging unit 110, the imaging unit 110 may be a light-receiving sensor configured to receive electroluminescent light generated from the photovoltaic wafer 1.

According to an embodiment of the present disclosure, the target image obtained through the imaging unit 110 may include a defect in the photovoltaic wafer 1.

According to an embodiment of the present disclosure, defects that may occur in the photovoltaic wafer 1 may be classified as faults or black spots.

The storage device 130 may store the target image obtained by the imaging unit 110. In addition, the storage device 130 may store training data for training a deep learning model. For example, the storage device 130 may be a large-capacity server capable of storing training data.

In detail, the training data may include a result classified as at least one defect identified in at least one training image of a photovoltaic wafer. In addition, the training image may be a previously captured image of at least one photovoltaic wafer, and may be an image including at least one defect.

According to an embodiment of the present disclosure, the storage device 130 may include first training data for training a fault detection deep learning model. The first training data may include a result of manually determining, by a human, a fault type in at least one first training image of a photovoltaic wafer. The fault detection deep learning model may be trained through supervised learning by using the first training data.

According to an embodiment of the present disclosure, the storage device 130 may include second training data for training a black spot classification deep learning model. The second training data may include a result of manually determining, by a human, a black spot type in at least one second training image of a photovoltaic wafer. The black spot classification deep learning model may be trained through supervised learning by using the second training data.

The defect detection device 200 may detect one or more defects included in the target image.

The defect detection device 200 of the photovoltaic wafer defect detection system according to an embodiment of the present disclosure may include a communication unit 210, a storage unit 230, a processor 250, and an alarm unit 270.

The communication unit 210 may receive the target image from the storage device 130.

Referring to FIG. 2, the imaging equipment 100 may further include an interface unit 120 for transmitting and receiving, to and from the defect detection device 200, information about the location of a target image, and a result of detecting a defect in a photovoltaic wafer.

For example, when a target image is generated from the imaging unit 110 and stored in the storage device 130, the interface unit 120 may transmit information about the storage location of the target image to the communication unit 210 of the defect detection device 200. The communication unit 210 may download the target image from the storage device 130 based on the storage location of the target image. For example, the interface unit 120 may use Transmission Control Protocol (TCP) to transmit information about the storage location of the target image, to the communication unit 210 of the defect detection device 200.

Referring to FIG. 3, the communication unit 210 of the defect detection device 200 may scan the storage device 130 in real time. When a target image is stored in the storage device 130, the communication unit 210 may recognize that the target image has been generated and receive the target image from the storage device 130. For example, the communication unit 210 may use a Server Message Block (SMB) protocol to scan the storage device 130 in real time and download a target image.

The storage unit 230 may store the target image received from the storage device 130, and when detecting a defect in the target image, transmit the target image to the processor 250. In addition, the storage unit 230 may store a fault detection deep learning model and a black spot classification deep learning model, for detecting a defect in a target image. For example, the storage unit 230 includes non-volatile storage capable of preserving data (information) regardless of whether power is provided, and volatile memory in which data to be processed by the processor 250 is loaded, and which cannot preserve data when power is not provided. The storage includes flash memory, a hard disk drive (HDD), a solid-state drive (SSD), read-only memory (ROM), etc., and the memory includes a buffer, random-access memory (RAM), etc.

The processor 250 may detect one or more defects in the photovoltaic wafer 1 based on the fault detection deep learning model and the black spot classification deep learning model.

According to an embodiment of the present disclosure, defects that may occur in the photovoltaic wafer 1 may be classified into faults and black spots.

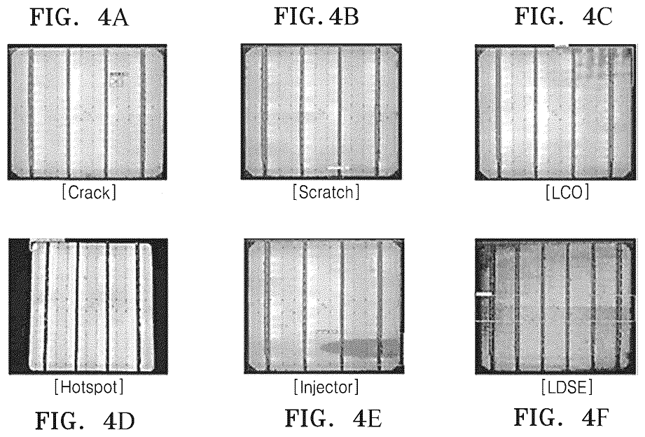

In detail, as shown in [Table 1] below, faults that may occur in the photovoltaic wafer 1 may be classified into six types: Crack, Scratch, LCO, Hotspot, Injector, and LDSE. The six types of faults may be represented as shown in FIG. 4. FIG. 4 shows specific images of fault types that may occur in the photovoltaic wafer 1.

TABLE 1

| No. | Defect class | Description of defect |
|---|---|---|
| 1 | Crack | Spider-shaped fault due to damage to a |
| | | photovoltaic wafer surface |
| 2 | Scratch | Scratch caused by mechanical impact on a |
| | | photovoltaic wafer surface |
| 3 | LCO | Fault where the photovoltaic wafer surface is |
| | | etched by using a laser and a paste is applied |
| | | thereon, but the positioning is misaligned |
| 4 | Hotspot | Defect that occurs during a chemical etching |
| | | process on a photovoltaic wafer surface |
| 5 | Injector | Fault that occurs in chamber equipment, where |
| | | chemicals are excessively sprayed onto a |
| | | specific region of a photovoltaic wafer. |
| 6 | LDSE | Fault that occurs during a laser etching |
| | | process on a photovoltaic wafer surface. |

According to an embodiment of the present disclosure, a black spot refers to a region that appears relatively black compared to other regions because a current cannot flow well due to resistance when electricity flows through the photovoltaic wafer 1. Black spots may occur due to the inflow of contaminants, etc. at the corresponding location during a photovoltaic wafer manufacturing process.

The processor 250 may use a fault detection deep learning model, a black spot detection algorithm, and a black spot classification deep learning model. In detail, the processor 250 may detect one or more faults in the photovoltaic wafer 1 based on the fault detection deep learning model. When no fault is detected in the photovoltaic wafer 1, the processor 250 may detect one or more black spots in the photovoltaic wafer 1 by using the black spot detection algorithm. In addition, when a black spot is detected in a target image, the processor 250 may classify the target image according to the type of the black spot by using the black spot classification deep learning model.

According to an embodiment of the present disclosure, the fault detection deep learning model and the black spot classification deep learning model may be models trained to detect an object from a target image according to a deep learning technique, and the deep learning technique may include deep neural network (DNN), convolutional neural network (CNN), recurrent neural network (RNN), restricted Boltzmann machine (RBM), deep belief network (DBN), deep Q-networks, etc., but is not limited thereto. For example, the deep learning model may use the YOLOv5 open source.

According to an embodiment of the present disclosure, the fault detection deep learning model and the black spot classification deep learning model may be trained by using training data stored in the storage device 130.

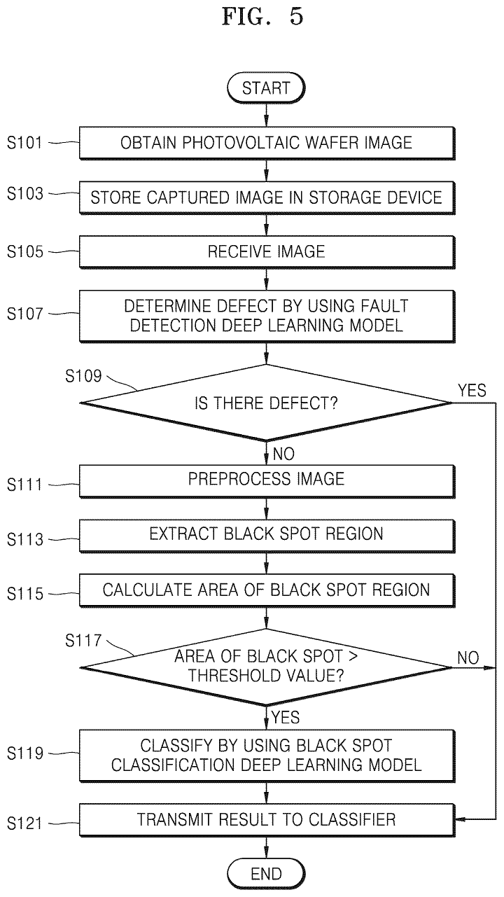

According to an embodiment of the present disclosure, the black spot detection algorithm may include an algorithm for preprocessing a target image, an algorithm for detecting a black spot from the preprocessed target image, an algorithm for calculating the area of the detected black spot region, and an algorithm for comparing the area of the black spot region with a threshold value to determine the presence or absence of a defect. A specific black spot detection algorithm will be described in detail below with reference to FIG. 5.

When a defect is detected by the processor 250, the alarm unit 270 may notify a user that the defect has occurred. For example, when defects occur continuously, the user may recognize that a problem has occurred in a photovoltaic wafer production process line, and stop the line.

The classifier 300 may classify the photovoltaic wafer 1 based on a result of detecting a defect in a target image. In detail, the classifier 300 may classify the photovoltaic wafer 1 as faulty, black spot, or normal. Faults may be classified into cracks, scratches, LCO, hotspots, injector, and LDSE.

Referring to FIG. 2, when a defect is detected in a target image, the defect detection device 200 transmits a defect detection result to the interface unit 120 through the communication unit 210. The classifier 300 may receive the defect detection result from the interface unit 120.

Referring to FIG. 3, when a defect is detected in a target image, the defect detection device 200 may transmit a defect detection result directly to the classifier 300 through the communication unit 210.

Accordingly, unlike the related-art defect detection systems that may detect only cracks from a target image, the present disclosure has an advantage of being able to detect and classify cracks, scratches, LCO, hotspots, injector, LDSE, or black spots.

In addition, the present disclosure has an advantage of improving detection accuracy by using a deep learning model in a photovoltaic wafer defect detection system.

FIG. 5 is a detailed flowchart of a method of detecting a defect in a photovoltaic wafer, according to an embodiment of the present disclosure.

Referring to FIG. 5, the imaging equipment 100 photographs the photovoltaic wafer 1 to obtain a target image (S101). The obtained target image is stored in the storage device 130 (S103).

The defect detection device 200 downloads the target image from the storage device 130 and stores it in the storage unit 230 (S105).

The processor 250 of the defect detection device 200 inputs the target image into the fault detection deep learning model, and determines the presence or absence of a fault (S107).

Here, when a fault corresponding to crack, scratch, LCO, hotspot, injector, or LDSE is detected in the target image as a result of defect detection, the detection result is transmitted to the classifier 300. When no fault is detected in the target image as a result of the defect detection, the image is input to the black spot detection algorithm (S109).

The black spot detection algorithm preprocesses the target image in which no fault has been detected (S111). Outlines, busbars, and other noise may be removed from the preprocessed target image, leaving only each cell constituting the photovoltaic wafer 1.

The black spot detection algorithm extracts a black spot region in consideration of the brightness of the preprocessed target image (S113).

According to an embodiment of the present disclosure, the brightness of the target image may vary depending on the imaging equipment and imaging conditions. The black spot detection algorithm may recognize the brightness of the target image and detect a black spot by using a relative brightness difference of the target image. For example, in a target image with a high brightness, the black spot detection algorithm may detect a gray region as a black spot. In addition, in a target image with a low brightness, a black region may be detected as a black spot.

The black spot detection algorithm calculates the area of the black spot region extracted from the preprocessed target image (S115).

Here, when the area of the black spot region is less than a threshold value, the black spot detection algorithm determines that the target image is normal, and transmits the result to the classifier 300. When the area of the black spot region is greater than or equal to the threshold value, the black spot detection algorithm inputs the target image into the black spot classification deep learning model (S117). For example, the threshold value may be 0.2% of the area of the photovoltaic wafer cell.

The target image including the black spot is classified according to the type of the black spot by using the black spot classification deep learning model (S119). Black spots may be classified into various types depending on which photovoltaic wafer manufacturing process they occurred in. For example, the types of black spots may include types caused by scratches on an ARC robot pad, types caused by contamination of an automation belt in a WB process, types caused by a finger broken in a printer process, etc.

The result of classifying the black spot included in the target image according to the type is transmitted to the classifier 300 (S121). The classifier 300 may classify the photovoltaic wafer 1 by black spot type based on the received result.

According to an embodiment of the present disclosure, it is possible to improve the accuracy of black spot detection, thereby reducing problems caused by under-detection and over-detection. In addition, by classifying black spots by type, it is possible to quickly identify an operation that causes defects in a photovoltaic wafer production process.

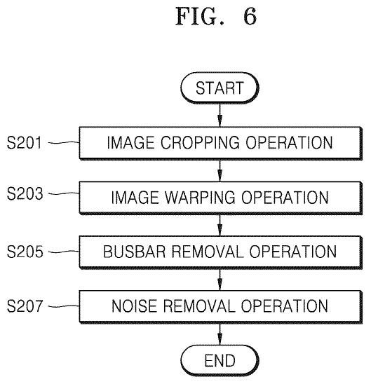

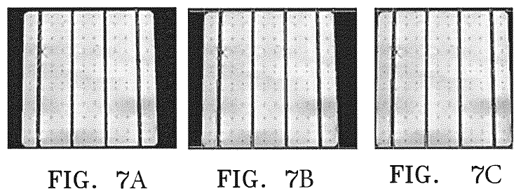

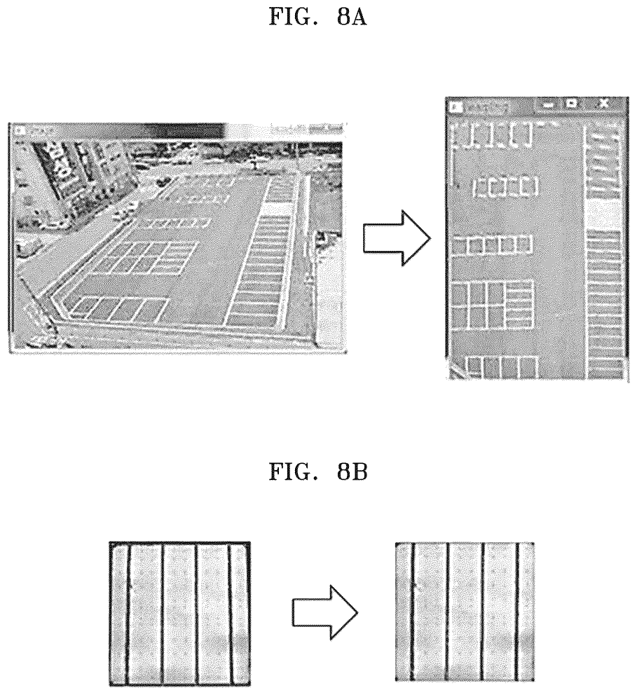

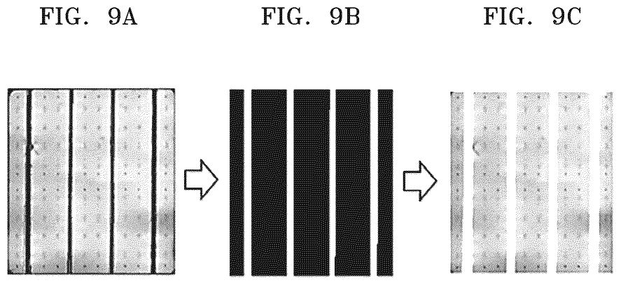

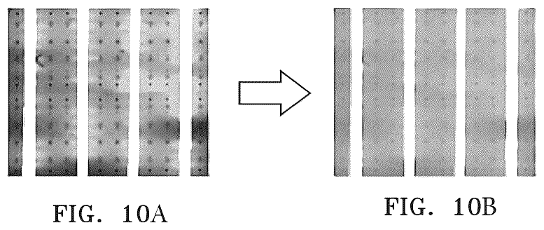

FIG. 6 is a detailed flowchart of a target image preprocessing method of a black spot detection algorithm. FIG. 7 is an image for describing in detail an image cropping operation of a preprocessing algorithm. FIG. 8 is an image for describing in detail an image warping operation of a preprocessing algorithm. FIG. 9 is an image for describing in detail a busbar removal operation of a preprocessing algorithm. FIG. 10 is an image for describing in detail a noise removal operation of a preprocessing algorithm.

Hereinafter, the target image preprocessing method of the black spot detection algorithm will be described with reference to FIGS. 6 to 10.

According to an embodiment of the present disclosure, the target image preprocessing algorithm included in the black spot detection algorithm includes image cropping, image warping, busbar removal, and noise removal operations.

First, the image cropping operation is an operation of extracting, from a target image, only a region corresponding to the photovoltaic wafer 1 (S201). In detail, referring to FIG. 7, when performing the image cropping operation, only the region corresponding to the photovoltaic wafer 1 in the target image may be extracted, and the surrounding region that does not correspond to the photovoltaic wafer 1 may be removed.

Next, the image warping operation is an operation of rotating the position of the target image to correct a distortion of the image caused by perspective (S203). For example, referring to (a) of FIG. 8, an image taken from the side may be converted into an image taken from the top by using image warping.

According to an embodiment of the present disclosure, referring to (b) of FIG. 8, a tilted cell image in the target image may be converted into a rectangular cell image by using image warping.

Next, the photovoltaic wafer 1 includes a plurality of busbars in a stripe form, and the busbar removal operation is an operation of removing a portion corresponding to the busbars from the target image (S205). For example, the reason for removing the busbars is that the black spot detection algorithm may incorrectly determine the busbars as black spots.

Referring to FIG. 9, according to an embodiment of the present disclosure, the busbars may be removed from the target image such that only the photovoltaic wafer cells remain. For example, a long filter having a shape similar to the busbar shape may be used to remove the busbars included in the target image.

In detail, (b) of FIG. 9 may be obtained by matching the positions of the bus included in (a) of FIG. 9 and the long filter and inverting the image. (c) of FIG. 9 with the busbars removed may be obtained by combining (b) of FIG. 8 obtained through image warping with (b) of FIG. 9.

Next, the noise removal operation is an operation of removing noise formed inside the cells of the photovoltaic wafer (S207). Because noise naturally occurs during a process of producing the photovoltaic wafer 1, noise may be removed from the target image through the noise removal operation, as shown in FIG. 10. For example, a plurality of black dots may appear inside the cells in the target image. Because these black dots correspond to electrode pad portions, it is necessary to remove them by using a filter to prevent the black spot detection algorithm from incorrectly determining the plurality of black dots as black spots.

According to an embodiment of the present disclosure, after preprocessing a target image, a black spot included in the preprocessed target image may be detected and its area may be calculated, by using the black spot detection algorithm.

According to an embodiment of the present disclosure, by accurately detecting black spots by using an algorithm, it is possible to suppress factors that increase manufacturing costs in a photovoltaic wafer manufacturing process, and to increase the reliability of a photovoltaic wafer.

Although specific embodiments have been described in the detailed description of the present disclosure, modifications and changes may be made thereto without departing from the scope of the present disclosure. Therefore, the scope of the present disclosure should not be limited to the described embodiments, but should be determined by the appended claims and their equivalents.

1. A system for detecting a defect in a photovoltaic wafer, the system comprising:
imaging equipment configured to obtain a target image of a photovoltaic wafer; and
a defect detection device configured to determine presence or absence of at least one defect in the photovoltaic wafer in the target image,
wherein the defect detection device is further configured to detect the presence or absence of the at least one defect, which comprises a defective state with at least one fault in the photovoltaic wafer based on a fault detection deep learning model, and at least one black spot present on the photovoltaic wafer based on a black spot detection algorithm, and a normal state of the photovoltaic wafer.

2. The system of claim 1, wherein the fault detection deep learning model is trained by training data associated with at least one defect identified in at least one training image of the photovoltaic wafer.

3. The system of claim 1, wherein the black spot detection algorithm is configured to, based on an area of a region of the black spot detected in the target image being greater than or equal to a threshold value, determine the photovoltaic wafer to be in the defective state.

4. The system of claim 3, wherein the black spot detection algorithm is further configured to, based on the area of the region of the black spot being less than the threshold value, determine the photovoltaic wafer to be in the normal state.

5. The system of claim 4, wherein the imaging equipment further comprises an interface unit configured to transmit and receive, to and from the defect detection device, a location of a storage device in which the target image is stored, and a result of detecting a defect in the photovoltaic wafer.

6. The system of claim 5, wherein the defect detection device is further configured to scan the storage device in real time, and download, based on the target image being stored in the storage device, the target image from the storage device.

7. The system of claim 1, wherein the defect detection device further comprises an alarm unit configured to, based on the photovoltaic wafer being in the defective state, provide an alarm.

8. A device for detecting a defect in a photovoltaic wafer, the device comprising:
a storage unit storing a fault detection deep learning model and a black spot classification deep learning model both configured to detect presence or absence of a defect of a photovoltaic wafer in a target image of the photovoltaic wafer, wherein the target image is obtained by imaging equipment; and
a processor configured to detect any one of a defective state or a normal state of the photovoltaic wafer, based on the target image, the fault detection deep learning model, and the black spot classification deep learning model.

9. A method of detecting a defect in a photovoltaic wafer by using a device for detecting a defect in a photovoltaic wafer, the method comprising:
receiving, by a defect detection device, a target image of the photovoltaic wafer obtained from imaging equipment; and
detecting, by the defect detection device, presence or absence of at least one defect in the photovoltaic wafer, based on the target image,
wherein, in the detecting of the presence or absence of the at least one defect, the presence or absence of the at least one defect comprises a defective state with at least one fault in the photovoltaic wafer based on a fault detection deep learning model, and at least one black spot present on the photovoltaic wafer based on a black spot detection algorithm, and a normal state of the photovoltaic wafer.

10. The method of claim 9, further comprising generating, by the defect detection device, the fault detection deep learning model through learning of training data associated with at least one defect identified in at least one training image of the photovoltaic wafer.

11. The method of claim 9, wherein the detecting of the presence or absence of the at least one defect comprises:
preprocessing the target image by using the black spot detection algorithm;
calculating an area of a region of the black spot detected in the preprocessed target image; and
based on the area of the region of the black spot being greater than or equal to a threshold value, determining the photovoltaic wafer to be in the defective state.

12. The method of claim 11, wherein the detecting of the presence or absence of the at least one defect comprises, based on the area of the black spot region being less than the threshold value, determining the photovoltaic wafer to be in the normal state.

13. The method of claim 11, wherein the preprocessing of the target image comprises:
correcting an angle in the target image; and
removing busbars and noise from the target image.

14. The method of claim 11, further comprising, prior to the calculating of the area of the region of the black spot:
determining, by the defect detection device, a brightness of the target image; and
determining the region of the black spot according to the brightness of the target image.

15. The method of claim 9, further comprising, based on the photovoltaic wafer being in the defective state, providing, by the defect detection device, an alarm.
